(19) United States
(12) Patent Application Publication
(10) Pub. No.: US 2026/0368556 A1
(43) Pub. Date: Nov. 19, 2026

(54) ELECTRONIC DEVICE AND METHOD FOR TRAINING ARTIFICIAL INTELLIGENCE MODEL

(71) Applicant: SAMSUNG ELECTRONICS CO., LTD., Suwon-si (KR)

(72) Inventors: Juyoung LEE, Suwon-si (KR); Yongsung KIM, Suwon-si (KR); Daehyun BAN, Suwon-si (KR); Sangwon LEE, Suwon-si (KR); Hyunsoo CHOI, Suwon-si (KR)

(73) Assignee: SAMSUNG ELECTRONICS CO., LTD., Suwon-si (KR)

(21) Appl. No.: 19/094,122

(22) Filed: Mar. 28, 2025

Related U.S. Application Data
(63) Continuation of application No. PCT/KR2023/011507, filed on Aug. 4, 2023.

(30) Foreign Application Priority Data
Sep. 29, 2022 (KR) 10-2022-0124703
Dec. 6, 2022 (KR) 10-2022-0169099

(51) Int. Cl. G06N 5/04

(52) U.S. Cl. CPC G06N 5/04

(57) ABSTRACT

A method of training an Artificial Intelligence (AI) model, includes obtaining a merged data set, based on source data sets, wherein the merged data set includes Ground-Truth (GT) classes from among the source data sets that include GT data; obtaining a prediction result by applying first data samples of the merged data set to the AI model, and calculating a first loss based on the prediction result and first GT data of the first data samples; calculating a second loss, based on the first loss and first loss weight value information corresponding to the first data samples; and generating an updated AI model by updating at least one parameter of the AI model, based on the second loss.

### CROSS-REFERENCE TO RELATED APPLICATIONS

This application is a by-pass continuation application of International Application No. PCT/KR2023/011507, filed on Aug. 4, 2023, which is based on and claims priority to Korean Patent Application No. 10-2022-0124703, filed on Sep. 29, 2022, and Korean Patent Application No. 10-2022-0169099, filed on Dec. 6, 2022, in the Korean Intellectual Property Office, the disclosures of which are incorporated by reference herein in their entireties.

### TECHNICAL FIELD

### 1. Field

An electronic device and method for training an artificial intelligence model based on a plurality of data sets are provided.

### 2. Description of Related Art

A method of training an artificial intelligence model based on multiple data sets may involve training the artificial intelligence model in a multi-task type by assigning a task to each data set. If a head corresponding to a part that infers a result is added to each data set, the computational amount of the model may increase, the appearance frequency of each data set may be adjusted to be constant with respect to the head of the data set, or each data set may include a sufficiently large number of classes.

Various embodiments of the disclosure may reduce loss when a head is not included in each data set in the training an artificial intelligence model based on multiple data sets.

### SUMMARY

According to an aspect of the disclosure, a method of training an Artificial Intelligence (AI) model, includes obtaining a merged data set, based on a plurality of source data sets, wherein the merged data set includes a plurality of Ground-Truth (GT) classes from among the plurality of source data sets that include GT data; obtaining a prediction result by applying a first plurality of data samples of the merged data set to the AI model, and calculating a first loss based on the prediction result and first GT data of the first plurality of data samples; calculating a second loss, based on the first loss and first loss weight value information corresponding to the first plurality of data samples; and generating an updated AI model by updating at least one parameter of the AI model, based on the second loss.

The calculating the second loss may include identifying a first plurality of source data sets corresponding to the first plurality of data samples; determining second loss weight value information of the first plurality of source data sets, based on at least one of information about a first plurality of GT classes of the first plurality of source data sets or information about a plurality of degrees of learning progress of the AI model; and calculating the second loss, based on the first loss and the second loss weight value information.

The determining the second loss weight value information may include identifying whether all classes of the merged data set are the first plurality of GT classes, based on the information about the first plurality of GT classes; determining a first loss weight value mapped to the first plurality of GT classes and a second loss weight value mapped to all of the classes of the merged data set, excluding the first plurality of GT classes, such that the first loss weight value is greater than or equal to the second loss weight value; and determining the second loss weight value information of the first plurality of source data sets. The second loss weight value information may include the first loss weight value and the second loss weight value.

The information about the plurality of degrees of the learning progress may include at least one of a confidence of the AI model or a learning step of the AI model. The determining the first loss weight value and the second loss weight value may include determining the confidence of the AI model or the learning step of the AI model; and determining a decrease of the second loss weight value, based on at least one of the confidence of the AI model or the learning step of the AI model increasing.

The determining the first loss weight value and the second loss weight value may include calculating the second loss weight value, based on Equation rᵢ=1/((1+Cᵢ)^{a}×(e−1)×β1), based on the first loss weight value being 1, wherein i is an identifier of a class, ri is a second loss weight value mapped to the class i, ci is a confidence of an AI model corresponding to the class i, e is a learning step of the AI model expressed as an integer of 1 or more, a is a first configured value, and β is a second configured value.

The determining the confidence of the AI model or the learning step of the AI model may include obtaining a plurality of prediction results for the class i by applying, to the AI model, a second plurality of data samples of the merged data set including second GT data of the class i; and determining the confidence of the AI model corresponding to the class i, based on the plurality of prediction results and the second GT data.

The determining of the first loss weight value and the second loss weight value may include determining the learning step of the AI model, and the learning step of the AI model may be determined, based on a number of times the AI model has learned a plurality of data samples including the first plurality of data samples.

The first loss may be calculated by applying the prediction result and the first GT data to a loss function, and the loss function may be based on at least one of cross-entropy loss, hinge loss, mean absolute error (MAE), mean squared error (MSE), Kullback-Leibler divergence (KLD) loss, Huber loss, or root mean squared error (RMSE).

The method may further include identifying a first GT region corresponding to the first GT data from a second plurality of data samples in the merged data set; obtaining a first GT data sample including the first GT region; and updating a parameter of the AI model, based on the first GT data sample.

The obtaining the first GT data sample may include obtaining a second GT data sample from the second plurality of data samples that excludes the first GT region, and setting the second GT data sample to a third configured value.

The AI model may include at least one of a classification model, an object detection model, a segmentation model, a pose estimation model, a Human Object Interaction (HOI) model, or a visual relationship detection (VRD) model.

According to an aspect of the disclosure, an electronic device for training an Artificial Intelligence (AI) model, includes memory storing instructions; and at least one processor, wherein the instructions, when executed by the at least one processor, cause the electronic device to obtain a merged data set, based on a plurality of source data sets, wherein the merged data set includes a plurality of Ground-Truth (GT) classes from among the plurality of source data sets that include GT data; obtain a prediction result by applying a first plurality of data samples of the merged data set to the AI model, and calculate a first loss based on the prediction result and first ground-truth data of the first plurality of data samples; calculate a second loss, based on the first loss and first loss weight value information corresponding to the first plurality of data samples; and generate an updated AI model by updating at least one parameter of the AI model, based on the second loss.

The instructions, when executed by the at least one processor, may cause the electronic device to identify a first plurality of source data sets corresponding to the first plurality of data samples; determine second loss weight value information of the first plurality of source data sets, based on at least one of information about a first plurality of GT classes of the first plurality of source data sets or information about a plurality of degrees of learning progress of the AI model; and calculate the second loss, based on the first loss and the second loss weight value information.

The instructions, when executed by the at least one processor, may cause the electronic device to identify whether all classes of the merged data set are the first plurality of GT classes based on the information about the first plurality of GT classes; determine a first loss weight value mapped to the first plurality of GT classes and a second loss weight value mapped to all of the classes of the merged data set, excluding the first plurality of GT classes, such that the first loss weight value is greater than or equal to the second loss weight value; and determine the second loss weight value information of the first plurality of source data sets, wherein the second loss weight value information may include the first loss weight value and the second loss weight value,

According to an aspect of the disclosure, a non-transitory computer-readable recording medium having instructions recorded thereon, that, when executed by one or more processors, cause the one or more processors to obtain a merged data set, based on a plurality of source data sets, wherein the merged data set includes a plurality of Ground-Truth (GT) classes from among the plurality of source data sets that include GT data; obtain a prediction result by applying a first plurality of data samples of the merged data set to the AI model, and calculate a first loss based on the prediction result and first ground-truth data of the first plurality of data samples; calculate a second loss, based on the first loss and first loss weight value information corresponding to the first plurality of data samples; and generate an updated AI model by updating at least one parameter of the AI model, based on the second loss.

### BRIEF DESCRIPTION OF THE DRAWINGS

The above and other aspects, features, and advantages of certain embodiments of the present disclosure are more apparent from the following description taken in conjunction with the accompanying drawings, in which:

FIGS. 1A and 1B are views for describing a source data set and a merged data set, according to an embodiment.

FIG. 2 is a view for describing a method of determining a first loss and a second loss, according to an embodiment.

FIG. 3 is a view for describing a method of determining a loss weight value, based on a degree of learning progress, according to an embodiment.

FIGS. 4A and 4B are views for describing a method of obtaining a ground-truth (GT) processing data sample according to an embodiment.

FIG. 5 is a view related to a method of performing a pose estimation task by using an Artificial Intelligence (AI) model according to an embodiment.

FIG. 6 is a view related to a method of performing a segmentation task by using an AI model according to an embodiment.

FIG. 7 is a view related to a method of performing a visual relationship detection (VRD) task by using an AI model according to an embodiment.

FIG. 8 is a flowchart related to a method of training an AI model according to an embodiment.

FIGS. 9A and 9B are block diagrams related to an electronic device according to an embodiment.

### DETAILED DESCRIPTION

The embodiments described in the disclosure, and the configurations shown in the drawings, are only examples of embodiments, and various modifications may be made without departing from the scope and spirit of the disclosure.

The expressions “at least one of A, B and C” and “at least one of A, B, or C”, both indicate “A”, only “B”, only “C”, both “A and B”, both “A and C”, both “B and C”, and all of “A, B, and C”.

Although widely used terms may be selected for terminology in the present disclosure while considering the functions in the disclosure, such terms may vary according to intentions of one of ordinary skill in the art, judicial precedents, the advent of new technologies, and the like. Terms arbitrarily selected may also be used in a various cases and their meanings may be described in the corresponding description. Hence, the terms used in the disclosure must be defined based on the meanings of the terms and the entire content of the disclosure, not by simply the terms themselves.

The singular forms “a,” “an,” and “the” include plural referents unless the context clearly dictates otherwise. All technical or scientific terms used herein have the same meaning as commonly understood by one of ordinary skill in the technical art of the disclosure. In the disclosure, although the terms including ordinal numbers, such as “first”, “second”, for example, may be used herein to describe various components, these components should not be limited by these terms. These terms are only used to distinguish one component from another.

When a certain part “includes” a certain component, the part does not exclude another component but can further include another component, unless the context clearly dictates otherwise. The terms “portion”, “part”, “module”, for example, used the disclosure refer to a unit for processing at least one function or operation, which may be implemented as hardware, software, or a combination of hardware and software.

Functions related to Artificial Intelligence (AI) according to the present disclosure may operate through a processor and memory. The processor may be configured with one or more processors. The one or more processors may be a Central Processing Unit (CPU), an Application Processor (AP), a Digital Signal Processor (DSP), a graphics-dedicated processor, such as Graphics processing Unit (GPU), a Vision Processing Unit (VPU), or an AI-dedicated processor, such as Neural Processing Unit (NPU), for example. The one or more processors may control processing of input data according to a pre-defined operation rule or AI model stored in the memory. When the one or more processors are AI-dedicated processors, the AI-dedicated processors may be designed with a hardware structure for processing a AI model.

The pre-defined operation rule or AI model may be generated through training. Herein, being generated through training means that a pre-defined operation rule or AI model configured to perform a desired characteristic (or purpose) is generated by training an AI model with multiple pieces of training data according to a learning algorithm. The training may be performed by a device of performing AI according to the present disclosure or through a separate server and/or system. Examples of the learning algorithm may include supervised learning, unsupervised learning, semi-supervised learning, or reinforcement learning, although not limited thereto.

The AI model may be configured with a plurality of neural network layers. Each of the plurality of neural network layers may have a plurality of weight values, and perform neural network computation through computation of a computation result of a previous layer and the plurality of weight values. A plurality of weight values of the plurality of neural network layers may be optimized by a training result of the AI model. For example, the plurality of weight values may be renewed or updated such that loss values or cost values obtained from the AI model during a training process are reduced or minimized. An artificial neural network may include Deep Neural Network (DNN), and for example, the artificial neural network may include Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), or Deep Q-Networks, although not limited thereto.

A data set may be a set of data including a plurality of data samples. A data sample means datum constituting a data set. The data sample may include or correspond to statistical data, text, audio, an image, or video, for example. The data sample may include raw data. The data sample may include information representing a data characteristic, obtained by preprocessing the raw data. The data set may be stored in memory or storage in an electronic device. The data set may be stored in external storage of an electronic device.

A label may be meaningful information associated with a data sample. The label may represent or define an attitude of the data sample. In an embodiment, a label may be information included in a data sample or information associated with the data sample.

The label may include a class label or a class, and the class may be criterion for classifying or evaluating the data sample or an object included in the data sample. The label may include a result obtained by performing inference or prediction based on the data sample. The label is not limited to the above-described embodiment, and any meaningful information associated with a data sample may be assigned as a label. A behavior of assigning a label may be expressed as labeling.

Ground-truth (GT) data may be expressed in various terms, such as measurement information, measurement data, observation data, answer data, answer information, monitoring information, observation information, ground truth information, or a labeled result of a data sample. GT data may be information included in a data sample, information corresponding to a data sample, information associated with a data sample, or information mapped to a data sample. GT data may be associated with, correspond to, or is mapped to one or more labels. In an embodiment, a class corresponding to GT data or a class mapped to GT data may be expressed as a GT class.

An embodiment of the disclosure will be described in detail with reference to the accompanying drawings such that one of ordinary skill in the technical art to which the present disclosure belongs can implement the embodiment. The disclosure may, be embodied in different forms without being limited to the express embodiment set forth herein. Throughout the disclosure, similar portions are assigned similar reference numerals.

The disclosure will be described in detail with reference to the accompanying drawings.

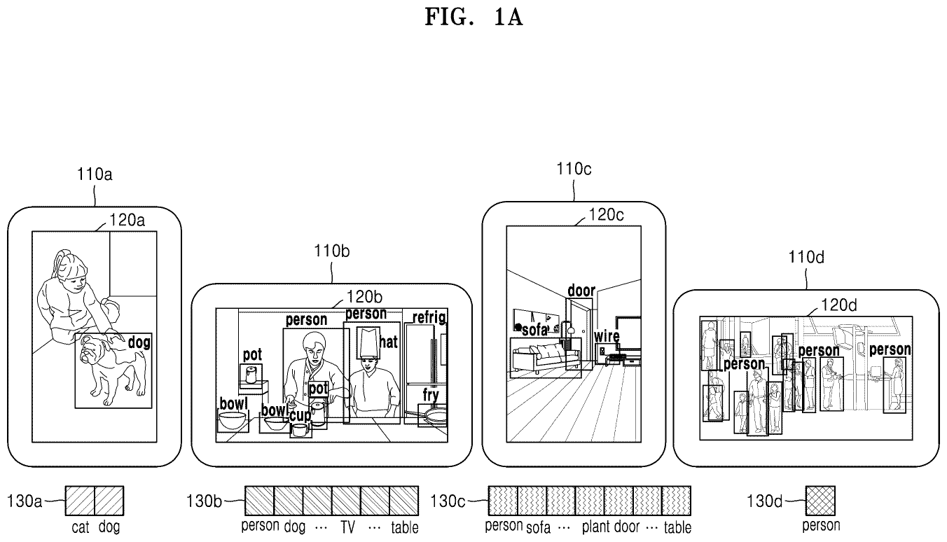

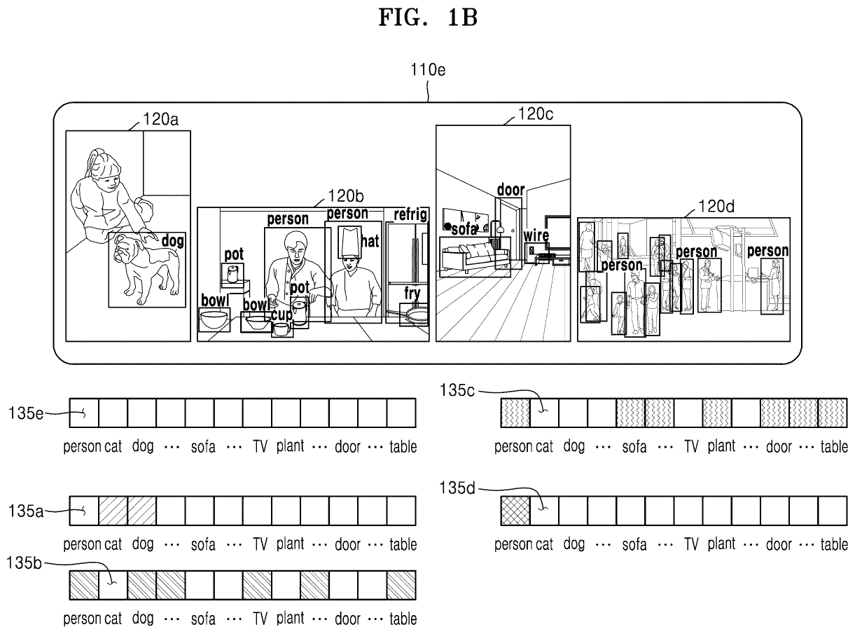

FIGS. 1A and 1B are views for describing a source data set and a merged data set according to an embodiment.

A data set may include a plurality of data samples, and, for example, referring to FIG. 1A, a source data set 110a may include a plurality of data samples including a data sample 120a. A data sample may include or correspond to statistical data, text, audio, an image, or video, for example. For example, referring to FIGS. 1A and 1B, data samples 120a, 120b, 120c, and 120d may correspond to images.

A source data set may be understood as a data set based on which a merged data set is obtained. For example, referring to FIGS. 1A and 1B, a merged data set 110e may be obtained based on four source data sets 110a, 110b, 110c, and 110d.

A source data set may include a plurality of data samples in which GT data corresponds to a class. In the case of a data sample included in the source data set 110a, GT classes 130a corresponding to GT data may correspond to {cat, dog}. A GT class may be expressed as a class corresponding to GT data, a class mapped to GT data, or a class in which GT data exists.

The source data set 110b may include a plurality of data samples including the data sample 120b, wherein GT data may correspond to a person class, a dog class, a bowl class, a TV class, a hat class, a pot class, a cup class, a frying pan class, a refrigerator class, and a table class. GT classes 130b of the source data set 110b may be expressed as {person, dog . . . , TV, . . . , table}.

The source data set 110c may include a plurality of data samples including the data sample 120c, wherein GT data may correspond to a person class, a sofa class, a plant class, a door class, and a table class. GT classes 130c of the source data set 110c may be expressed as {person, sofa, . . . , plant, . . . , door, . . . , table}.

The source data set 110d may include a plurality of data samples including the data sample 120d, wherein GT data may correspond to a person class. For example, a GT class 130d of the source data set 110d may be expressed as {person}.

A merged data set may include at least one data sample included in each source data set. For example, referring to FIGS. 1A and 1B, the merged data set 110e may include the data samples 120a, 120b, 120c, and 120d.

A class of a merged data set may include a GT class of a source data set. For example, referring to FIGS. 1A and 1B, all classes 135e of the merged data set may include all the GT classes 130a, 130b, 130c, and 130d of the plurality of source data sets 110a, 110b, 110c, and 110d, and may be expressed as {person, cat, dog, . . . , sofa, . . . , TV, plant, door, . . . , table}. As another example, when an electronic device obtains a merged data set based on the two source data sets 110a and 110d, all classes of the merged data set may be {person, cat, dog}.

All classes of a merged data set may be configured with a GT class and all classes excluding the GT class. For example, referring to FIGS. 1A and 1B, the all classes 135e of the merged data set obtained based on the four source data sets 110a, 110b, 110c, and 110d may be configured with the GT classes 130a, 130b, 130c, and 130d and all classes 135a, 135b, 135c, and 135d excluding the GT classes.

The all classes 135a excluding the GT classes of the source data set 110a may be expressed as {person, . . . , sofa, . . . , TV, plant, . . . , door, . . . , table} excluding {dog, cat}. The all classes 135b excluding the GT classes of the source data set 110b may be expressed as {cat, sofa, . . . , plant, . . . , door, . . . }. The all classes 135c excluding the GT classes of the source data set 110c may be expressed as {cat, dog, . . . , TV, . . . }. The all classes 135d excluding the GT class of the source data set 110d may be expressed as {cat, dog, . . . , sofa, . . . , TV, plant, . . . , door, . . . , table}.

For convenience of description, classes are expressed in the form of sets. Classes may be expressed as arrays, vectors, or matrices, and are not limited to the above-mentioned expressions. A prediction result corresponding to a class, GT data corresponding to a class, or loss weight value information may also be expressed in various ways including the above-mentioned expressions.

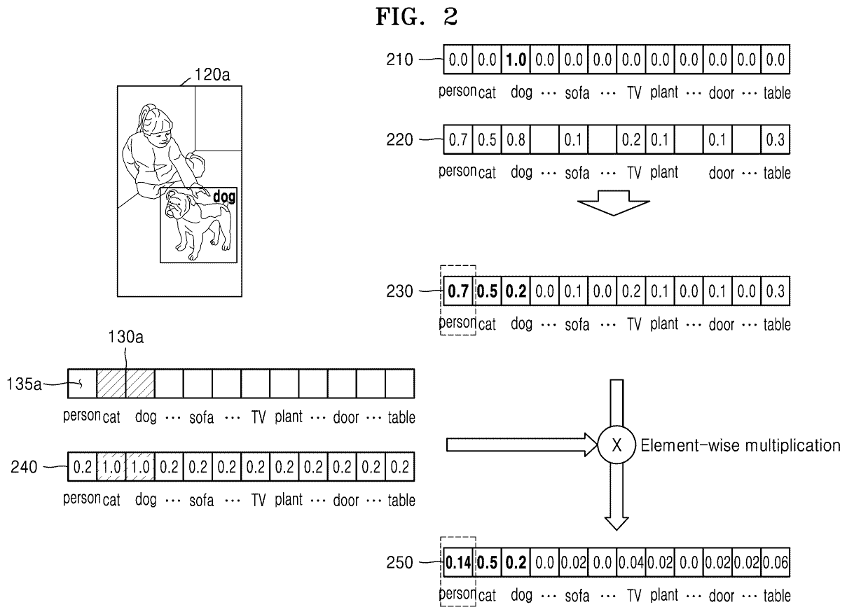

FIG. 2 is a view for describing a method of determining a first loss and a second loss according to an embodiment.

An electronic device may calculate a second loss based on a first loss and loss weight value information corresponding to a first data sample. The electronic device may calculate the first loss based on GT data of a first data sample included in a merged data set and a prediction result obtained by applying the first data sample to the AI model.

The prediction result may include a prediction result corresponding to all classes of the merged data set. For example, referring to FIG. 2, the electronic device may obtain a prediction result 220 as an output by inputting the first data sample 120a to the AI model. The prediction result 220 may include a value of 0.7 corresponding to a person class, a value of 0.5 corresponding to a cat class, or a value of 0.8 corresponding to a dog class, for example.

The GT data of the first data sample may include GT data corresponding to all classes of the merged data set. The GT data of the first data sample may include GT data corresponding to a GT class and GT data corresponding to all classes excluding the GT class. In an embodiment, in the GT data of the first data sample, a value corresponding to the all classes excluding the GT class may be set to a default value such as 0.

For example, GT data 210 of the first data sample 120a may include a value of 0 corresponding to a cat class and a value of 1 corresponding to a dog class with respect to the GT classes 130a. The GT data 210 of the first data sample 120a may include a default value of 0 with respect to the all classes 135a excluding the GT classes.

The GT data 120 of the data sample 120a may indicate that there is no cat and indicate that an object corresponding to a dog is included. The GT data 210 of the data sample 120a may indicate a position of the object as a bounding box or pixel corresponding to the dog.

In an embodiment, the electronic device may calculate a first loss based on a difference between the prediction result and the GT data. A loss value corresponding to a class i may be calculated based on a difference between a prediction result corresponding to the class i and GT data corresponding to the class i.

For example, referring to FIG. 2, a first loss 230 may include a loss value of 0.7 corresponding to a difference between a prediction result of 0.7 corresponding to the person class and GT data of 0 corresponding to the person class. The first loss 230 may include a loss value of 0.5 corresponding to the cat class and a loss value of 0.2 corresponding to the dog class.

In an embodiment, the electronic device may calculate a first loss by applying the prediction result of the first data sample and the GT data of the first data sample to a loss function.

The loss function may include at least one of cross-entropy loss, hinge loss, mean absolute error (MAE), mean squared error (MSE), Kullback-Leibler divergence (KLD) loss, Huber loss, or root mean squared error (RMSE). The loss function is not limited to the above-mentioned loss functions, and various loss functions and cost functions may be applied.

The electronic device may determine a second loss that is less than or equal to the first loss, with respect to all classes of the merged data set excluding the GT class of the first data sample. When the AI model outputs an uncertain prediction result with respect to a class including no GT data, the AI model may be updated based on a second loss that is less than or equal to a first loss.

The electronic device may calculate the second loss based on the first loss and the loss weight value information corresponding to the first data sample. The loss weight value information may include loss weight values mapped to classes of the merged data set.

The loss weight value information may include a first loss weight value mapped to the GT class and a second loss weight value mapped to the all classes excluding the GT class. In an embodiment, when the first loss weight value is 1, the second loss weight value may be set to a value that is greater than or equal to 0 and less than or equal to 1.

The electronic device may determine a second loss that is less than or equal to a first loss.

For example, referring to FIG. 2, in loss weight value information 240 corresponding to the first data sample 120a, a first loss weight value mapped to the GT classes 130a of the first data sample may be set to 1 and a loss weight value mapped to the all classes 135a excluding the GT classes may be set to 0.2.

The electronic device may determine a second loss based on the loss weight value information and the first loss. For example, referring to FIG. 2, the electronic device may calculate a second loss 250 of 0.14 with respect to the person class based on the product of the first loss value of 0.7 corresponding to the person class and the loss weight value of 0.2 corresponding to the person class. For convenience of description, the product is used. A person of ordinary skill may calculate a second loss based on a loss weight value and a first loss in various different ways.

The electronic device may calculate a second loss based on a prediction result obtained by applying the first data sample to the AI model, the GT data of the first data sample, and the loss weight value information of the first data sample.

In an embodiment, the electronic device may calculate a second loss by applying a prediction result obtained by applying the first data sample included in the merged data set to the AI model, the GT data of the first data sample, and the loss weight value information to a loss function.

The loss function may include at least one of cross-entropy loss, hinge loss, MAE, MSE, KLD loss, Huber loss, or RMSE. The loss function is not limited to the above-mentioned loss functions, and various loss functions and cost functions may be applied.

For convenience of description, a first loss and a second loss are represented for each class. A first loss and a second loss may be obtained as an average or sum of losses for all classes and represented as a single value.

For example, in the case in which the loss function is MSE, a first loss may be calculated based on Equation

$$\frac{1}{n} {\sum }_{i = 1}^{n} {( {gt}_{i} - {pred}_{i} )}^{2}$$

and a second loss may be determined based on the following Equation

$$\frac{1}{n} {\sum }_{i = 1}^{n} {{r}_{i} ( {gt}_{i} - {pred}_{i} )}^{2} .$$

For example, in the case in which the loss function is RMSE, a first loss may be calculated based on Equation

$$\sqrt{\frac{1}{n} {\sum }_{i = 1}^{n} {( {gt}_{i} - {pred}_{i} )}^{2}}$$

and a second loss may be determined based on the following Equation

$$\sqrt{\frac{1}{n} {\sum }_{i = 1}^{n} {{r}_{i} ( {gt}_{i} - {pred}_{i} )}^{2}} .$$

For example, in the case in which the loss function is MAE, a first loss may be calculated based on Equation

$$\frac{1}{n} {\sum }_{i = 1}^{n} \vert {gt}_{i} - {pred}_{i} \vert$$

and a second loss may be determined based on the following Equation

$$\frac{1}{n} {\sum }_{i = 1}^{n} {r}_{i} \vert {gt}_{i} - {pred}_{i} \vert .$$

For example, in the case in which the loss function is cross-entropy loss, a first loss may be calculated based on Equation

$$- {\sum }_{i = 1}^{n} [ ( {gt}_{i} log ( {pred}_{i} ) + ( 1 - {gt}_{i} ) log ( 1 - {pred}_{i} ) ) ]$$

and a second loss may be determined based on the following Equation

$$- {\sum }_{i = 1}^{n} {r}_{i} [ ( {gt}_{i} log ( {pred}_{i} ) + ( 1 - {gt}_{i} ) log ( 1 - {pred}_{i} ) ) ] .$$

“i” may be defined as an identifier of a class, rᵢ may be defined as a loss weight value mapped to the class i, predᵢ may be defined as a prediction result corresponding to the class i, gtᵢ may be defined as GT data corresponding to the class i, and n may be defined as the number of classes.

In the case in which there is an object related to a person in the first data sample 120a, but there is no GT data corresponding to a person class or class of the first data sample 120a is set to a default value, the AI model may output a prediction result for the person class, indicating that an object related to a person is included. Updating the AI model based on the first loss may result in a feedback that the AI model has made an incorrect prediction in regard to a person.

Various embodiments may provide a method of updating an AI model based on a second loss that is less than a first loss, thereby preventing updating based on a great loss even when a prediction result is close to an actual correct answer. According to an embodiment, an AI model may be trained based on a data set in which GT data corresponding to classes is insufficient.

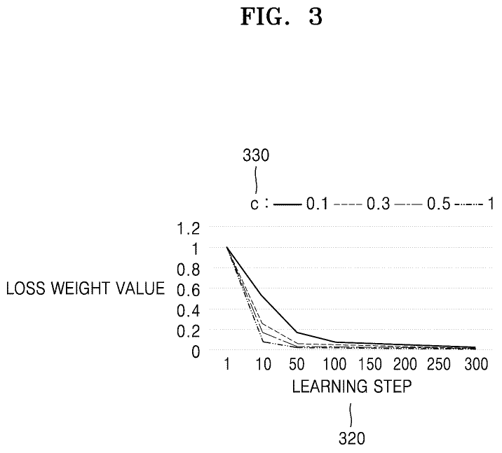

FIG. 3 is a view for describing a method of determining a loss weight value based on information about a degree of learning progress according to an embodiment.

In an embodiment, the electronic device may determine a loss weight value based on information about a degree of learning progress. In an embodiment, the information about the degree of learning progress may include at least one of a performance indicator of an AI model, including a confidence 330 of the AI model, or a learning step 320 of the AI model. When the at least one of the confidence 330 of the AI model or the learning step 320 of the AI model increases, the electronic device may determine a decrease of a second loss weight value mapped to all classes excluding a GT class.

The electronic device may determine the confidence 330 of the AI model or the learning step 320 of the AI model. The leaning step 320 of the AI model may be determined based on epoch or step corresponding to the number of times which a preset data set has been trained. Epoch is the number of times which a preset data set has passed through a neural network, and one epoch may be understood as a case where a preset data sample has passed through a neural network once through forward propagation and backpropagation.

For example, a step before a first data sample is applied to the AI model is defined as a learning step 1, and when a plurality of training data samples including the first data sample has passed through the AI model once or one epoch occurs, the learning step may increase to 2. As another example, a learning step may be determined based on the number of times which the AI model has been updated.

Referring to FIG. 3, the electronic device may determine the second loss weight value to gradually approach 0 from 1 as the learning step 320 increases. In an early stage of learning, a confidence of the AI model may be low, and a parameter of the AI model may be updated by determining a second loss weight value not mapped to GT classes to be 1 or close to 1. As leaning progresses using the AI model, the electronic device may detect an object existing in input data even without GT data, and the electronic device may determine the second loss weight value to gradually approach 0 from 1.

A confidence of an AI model may be one of indicators for evaluating performance of the AI model, and may include a confidence of the AI model corresponding to a class. In an embodiment, the confidence of the AI model may be obtained based on a second data sample of a validation set or a test set.

In an embodiment, the electronic device may obtain a plurality of second prediction results corresponding to a class i by applying, to the AI model, a plurality of second data samples in which GT data corresponds to the class i. The electronic device may determine a confidence of the AI model corresponding to the class i based on the plurality of second prediction results and the GT data of the plurality of second data samples.

For example, the electronic device may calculate the confidence by comparing the second prediction results corresponding to the class i to the GT data of the second data samples corresponding to the class i. An average of confidences calculated for the plurality of second data samples may be determined to be a confidence of the AI model corresponding to the class i.

As the confidence of the AI model corresponding to the class i is closer to 1, the GT data may be more identical to the prediction results of the model, and, as the confidence of the AI model is closer to 0, the GT data may be more different from the prediction results of the model.

Referring to FIG. 3, the electronic device may determine, as the confidence 330 of the AI model gradually increases to 0.1, 0.3, 0.5, and 1, the second loss weight value to gradually become closer to 0.

In an embodiment, when a first loss weight value is 1, the electronic device may calculate a second loss weight value based on Equation rᵢ=1/((1+Cᵢ)^{a}×(e−1)×β+1).

i may be defined as an identifier of a class, rᵢ may be defined as a second loss weight value mapped to the class i, cᵢ may be defined as a confidence of an AI model corresponding to the class i, e may be defined as a leaning step of the AI model, which is expressed as an integer that is greater than or equal to 1, a may be defined as a first configured value, and β may be defined as a second configured value. The first configured value and the second configured value may be received from another electronic device such as a server.

In an embodiment, the electronic device may calculate a second loss weight value based on Equation rᵢ=1/(e−1)×β+1) or rᵢ=1/(1+Cᵢ)^{a}×β+1).

i may be defined as an identifier of a class, rᵢ may be defined as a second loss weight value mapped to the class i, cᵢ may be defined as a confidence of an AI model corresponding to the class i, e may be defined as a leaning step of the AI model, which is expressed as an integer that is greater than or equal to 1, a may be defined as a first configured value, and β may be defined as a second configured value. The first configured value and the second configured value may be received from another electronic device such as a server, or may be set by the electronic device according to initial settings.

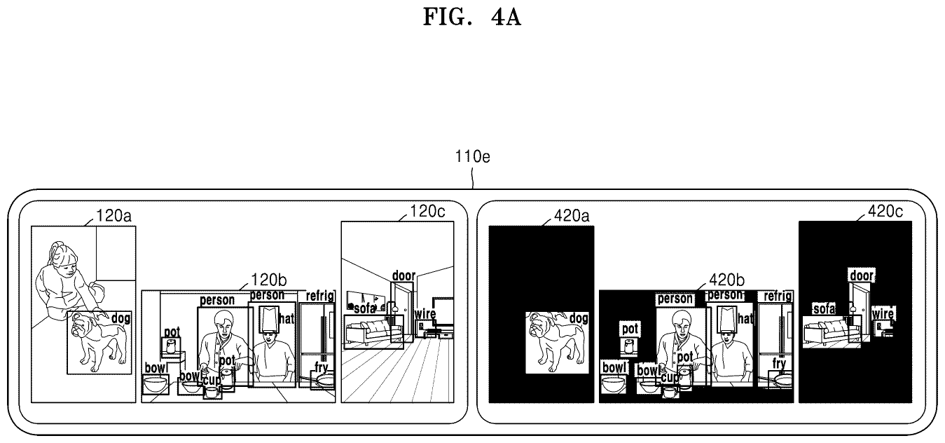

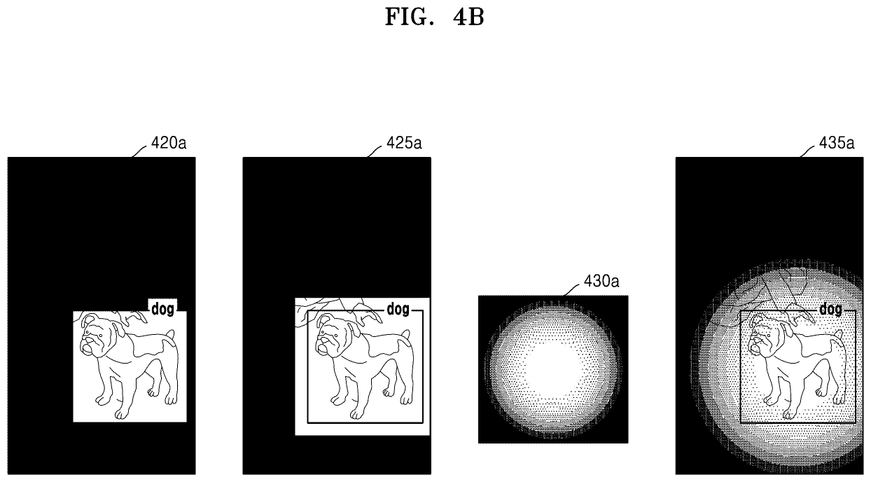

FIGS. 4A and 4B are views for describing a method of obtaining a GT processing data sample according to an embodiment.

A GT processing data sample may include a data sample in which at least a part of a region excluding a region corresponding to GT data has been erased by processing a data sample, and may be expressed as a GT data sample, or a processing data sample, for example. The electronic device may obtain a GT data sample including a GT region corresponding to GT data based on data samples included in a merged data set, and the merged data set may further include the GT data sample.

The electronic device may obtain the GT data sample including the GT region based on GT region information of the merged data set. The GT region information may include GT bounding box information, or GT pixel information, for example. In an embodiment, the electronic device may obtain a GT data sample by setting at least a part of a region excluding a GT region to a preset value.

The electronic device may obtain a GT data sample in which at least a part of a region of data samples excluding a GT region has been erased by setting the at least a part of the region of the data samples excluding the GT region to a preset value. The GT data sample may be a data sample in which data of at least a part of a region excluding a bounding box corresponding to the GT data has been erased or set to a preset value. The GT data sample may be a data sample in which data of at least a part of pixels excluding pixels corresponding to the GT data has been erased or set to a preset value.

For example, the electronic device may obtain a GT data sample 420a erased except for a bounding box indicating a dog based on the data sample 120a. The electronic device may obtain a GT data sample 420c erased except for a bounding box indicating a sofa, a bounding box indicating a door, and a bounding box indicating a wire based on the data sample 120a.

In an embodiment, in a GT data sample, at least one GT region, in addition to at least a part of a region excluding a region corresponding to GT data, may have been further erased or set to a preset value. For example, the electronic device may obtain a GT data sample erased except for the bounding box indicating the door based on the data sample 120c. In the GT data sample 420c, the bounding box indicating the sofa and the bounding box indicating the wire, corresponding to GT data, may also be erased.

For example, the electronic device may obtain a GT data sample erased except for bounding boxes indicating a left person and a right person based on the data sample 120b. The electronic device may obtain a GT data sample erased except for the bounding box indicating the left person or a GT data sample erased except for the bounding box indicating the right person based on the data sample 120b.

The electronic device may obtain a GT data sample based on padding information. For example, referring to FIG. 4B, a GT data sample 425a of which a size of padding is larger than the GT data sample 420a may be obtained. A size of padding may be fixed to a preset value such as 1/10 of a bounding box or may be set for each learning step of training AI. In an embodiment, the electronic device may receive padding information from another electronic device such as a server.

The electronic device may obtain a GT data sample by using a Gaussian filter. For example, referring to FIG. 4B, the electronic device may obtain a GT data sample 435a by using a Gaussian filter 430a at a center of a bounding box.

The electronic device may update a parameter of the AI model based on the GT data sample. For example, the electronic device may train the AI model and evaluate performance of the AI model based on the GT data sample and data samples included in an existing merged data set. The electronic device may train the AI model based on the GT data sample and evaluate performance of the AI model based on the data samples included in the existing merged data set.

In the case of training an AI model by obtaining a GT data sample, performance of the AI model may be improved against various variations and occlusions of input data.

According to various embodiments, an AI model may be trained based on original data samples included in an existing merged data set and train the AI model for a certain correct answer based on a GT data sample.

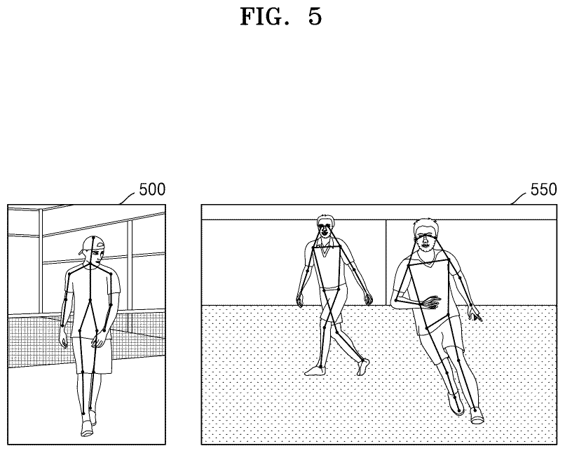

FIG. 5 is a view related to a method of performing a pose estimation task by using an AI model according to an embodiment.

A pose estimation task may be a task of estimating positions of human joints or body parts from an input image. The electronic device may train an AI model to output a result corresponding to a pose estimation task based on a data set including a plurality of images. The AI model may be expressed as a pose estimation model.

A trained AI model may output a prediction or inference value corresponding to the pose estimation task in response to an input image. A prediction result may include information about a body part including a joint, and the information about the body part may include at least one of position information, a probability, an index, or an identifier mapped to the body part.

A data sample included in the data set may be labeled in association with at least one of a body part including a joint or a position of the body part. With regard to the pose estimation task, a class of a data set may indicate a body part.

For example, referring to FIG. 5, a data set including a data sample 500 may be labeled in association with head, neck, shoulder, pelvis, or knee, for example. GT classes of the data set including the data sample 500 may be expressed as {head, neck, shoulder, pelvis, . . . , knee}.

A data set including a data sample 550 may be labeled in association with shoulder, knee, pelvis, finger, or face, for example. GT classes of the data set including the data sample 550 may be expressed as {shoulder, knee, pelvis, finger, . . . , face}.

The electronic device may obtain a merged data set based on a plurality of source data sets, which may correspond to operation S810. For example, the electronic device may obtain a merged data set based on the data set including the data sample 500 and the data set including the data sample 550. Classes of the merged data set may include head, neck, shoulder, knee, pelvis, finger, or face, for example.

The electronic device may calculate a second loss based on a prediction result obtained by applying a first data sample included in the merged data set to the AI model, GT data, and loss weight value information, which may correspond to operation S820 and operation S830.

In an embodiment, the electronic device may obtain a plurality of second prediction results by applying, to the AI model, a plurality of second data samples in which GT data corresponds to a class i. The electronic device may determine a confidence of the AI model corresponding to the class i based on the plurality of second prediction results and the GT data of the plurality of second data samples.

For example, referring to FIG. 5, with regard to the knee class, a data sample in which GT data corresponds to the knee class, like the data set including the data sample 500 and the data set including the data sample 550, may be used as a second data sample. The electronic device may determine a confidence of an AI model corresponding to the knee class based on a distance difference between the GT data of the second data sample and a prediction result obtained by applying the second data sample to the AI model.

With regard to the finger class, a data sample in which GT data corresponds to the finger class, like the data set including the data sample 550, may be used as a second data sample. The electronic device may determine a confidence of an AI model corresponding to the finger class based on a distance difference between the GT data of the second data sample and a prediction result.

The electronic device may update the AI model based on a second loss, which may correspond to operation S840. According to various embodiments, even when there is a class in which GT data does not exist in common in a plurality of data sets, such as the face class or the finger class, an AI model may be trained based on the plurality of data sets.

The electronic device may obtain a prediction value corresponding to a pose estimation task by inputting an image to the AI model. Referring to FIG. 5, an AI model which has been trained based on the data set including the data sample 500 and the data set including the data sample 550 may output at least one of position information or probability information mapped to head, neck, shoulder, knee, pelvis, finger, or face, for example, in response to an input image.

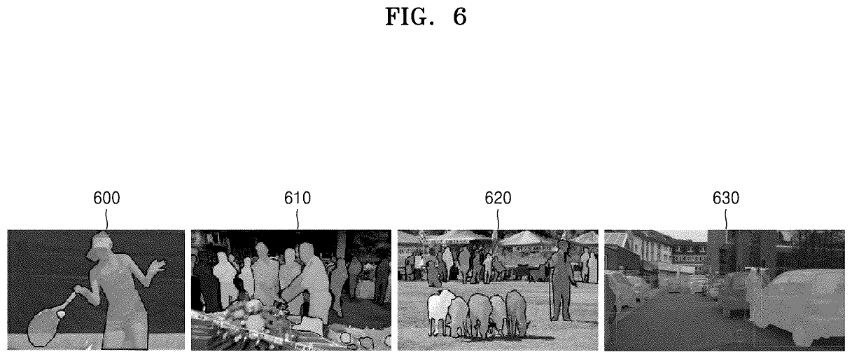

FIG. 6 is a view related to a method of performing a segmentation task by using an AI model according to an embodiment.

The segmentation task may be a task that performs classification of an input image for each pixel. The electronic device may train the AI model to output a result corresponding to a segmentation task based on a data set including a plurality of images. The AI model may be expressed as a segmentation model.

The trained AI model may output a prediction or inference value corresponding to a pose estimation task in response to an input image. A prediction result may include information indicating whether a pixel corresponds to a foreground or background. The foreground may be classified into a class of each object, such as person, dog, or table, for example.

GT data and a prediction result may be expressed as (W, H, C), wherein W may be defined as a width, H may be defined as a height, and C may be defined as a channel. In the case of a segmentation task, a channel may be understood as a class, and a length of a channel axis or the number of channels may be understood as the number of classes.

For example, referring to FIG. 6, a data set including a data sample 600 may be labeled with person, tennis racket, and ball, and may not be labeled with hat. GT classes of the data set including the data sample 600 may be expressed as {person, tennis racket, ball, background}.

A data set including a data sample 610 may be labeled with person and fruit. GT classes of the data set including the data sample 610 may be expressed as {person, fruit, background}. GT classes of a data set including a data sample 620 may be expressed as {person, animal, background}. GT classes of a data set including a data sample 630 may be expressed as {person, car, background}.

The electronic device may obtain a merged data set based on a plurality of source data sets, which may correspond to operation S810. For example, the merged data set may be obtained based on the data set including the data sample 610 and the data set including the data sample 630. All classes of the merged data set may be expressed as {person, tennis racket, ball, car, background}.

The electronic device may calculate a second loss based on a prediction result obtained by applying a first data sample included in the merged data set to the AI model, GT data, and loss weight value information, which may correspond to operation S820 and operation S830.

In an embodiment, the electronic device may obtain a plurality of second prediction results by applying, to the AI model, a plurality of second data samples in which GT data corresponds to a class i. The electronic device may determine a confidence of the AI model corresponding to the class i based on the plurality of second prediction results and the GT data of the plurality of second data samples.

For example, referring to FIG. 6, the electronic device may determine a confidence of an AI model for each channel based on differences between prediction results for all pixels and GT data. With regard to a person channel, data samples such as the data samples 600, 610, 620, and 630 in which the person channel exists may be used as second data samples. With regard to a car channel, the electronic device may use a data sample such as the data sample 630 in which the car channel exists, as a second data sample.

The electronic device may update the AI model based on the second loss, which may correspond to operation S840. According to various embodiments, even when there is a class in which GT data does not exist in common in a plurality of data sets, such as car or tennis racket, the AI model may be trained based on the plurality of data sets.

The electronic device may obtain a prediction value corresponding to a segmentation task by inputting an image to the AI model. For example, an AI model which has been trained based on the data set including the data sample 610 and the data set including the data sample 630 may output information indicating whether a pixel corresponds to at least one of person, tennis racket, ball, car, or background, in response to an input image.

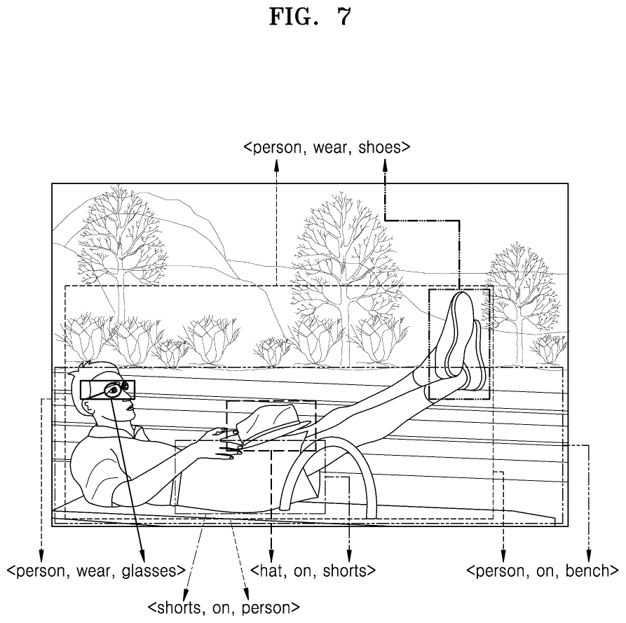

FIG. 7 is a view related to a method of performing a Visual relationship detection (VRD) task by using an AI model according to an embodiment.

The VRD task may be a task of identifying a pair of subject, predicate, and object, which may be expressed as (subject, predicate, object), with respect to an input image. An object corresponding to subject and an object corresponding to object may be detected through object detection. A Human Object Interaction (HOI) task may be a task in which subject is fixed to human in a VRD task.

The electronic device may train an AI model to output a result corresponding to a VRD task based on a data set including a plurality of images. The trained AI model may output a prediction or inference value corresponding to a VRD task in response to an input image. The AI model may be expressed as a VRD model or a HOI model.

GT data and a prediction result may include information about a pair of subject, predicate, and object. In the case of the VRD task, predicate may be understood as a class. A kind of predicate may be understood as the number of classes. For example, referring to FIG. 7, GT classes may be expressed as {on, wear}.

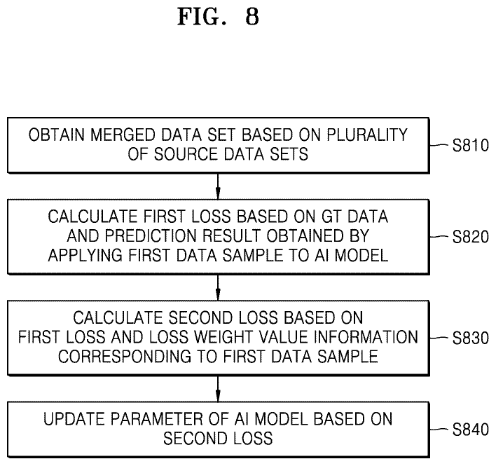

The electronic device may obtain a merged data set based on a plurality of source data sets, which may correspond to operation S810 of FIG. 8. The electronic device may calculate a second loss based on a prediction result obtained by applying a first data sample included in the merged data set to the AI model, GT data, and loss weight value information, which may correspond to operation S820 and operation S830. The electronic device may update the AI model based on the second loss, which may correspond to operation S840.

In an embodiment, the electronic device may obtain a plurality of second prediction results by applying, to the AI model, a plurality of second data samples in which GT data corresponds to a class i. The electronic device may determine a confidence of the AI model corresponding to the class i based on the plurality of second prediction results and GT data of the plurality of second data samples.

For example, the electronic device may determine a confidence of the AI model for a wear class by using, as a second data sample, a data sample corresponding to GT data with respect to predicate wear.

In a VRD task, one or more predicate may exist between subject and object. In many cases, different data sets may be provided with different labels. The VRD task may have difficulties in securing a plurality of data samples because labeling cost for data sets is high.

According to various embodiments, AI may be efficiently trained even when data samples are insufficient. By utilizing various embodiments, the AI model may be efficiently trained even when a plurality of pieces of GT data exist with respect to predicate for subject and object pairs.

FIG. 8 is a flowchart related to a method of training an AI model according to an embodiment.

In operation S810, the electronic device may obtain a merged data set based on a plurality of source data sets.

The electronic device may obtain a merged data set based on a plurality of source data sets. A data set based on which a merged data set is obtained may be expressed as a source data set. A data set may include a plurality of data samples, and a data sample may include or correspond to statistical data, text, audio, an image, or video, for example.

The electronic device may obtain a merged data set including all or some of data samples included in the plurality of source data sets. In an embodiment, a class corresponding to GT data is referred to as a GT class, and classes of the merged data set may include all GT classes of the plurality of source data sets. In an embodiment, the number of the classes of the merged data set may be greater than or equal to the number of the GT classes of the source data sets.

For example, when the plurality of source data sets include a first source data set and a second source data set, GT classes of the first source data set may be {c1, c2, c3}, and GT classes of the second source data set may be {c1, c2}. Classes of the merged data set may be {c1, c2, c3}.

As another example, when GT classes of the first source data set are {c1, c2, c3} and GT classes of the second source data are {c2, c3, c4} or {4}, classes of the merged data set may be {c1, c2, c3, c4}.

In an embodiment, the merged data set may be divided into a train set and a test set. The AI model may be trained based on data samples included in the train set, and performance of the AI model may be evaluated based on data samples included in the test set.

In an embodiment, the merged data set may be divided into a train set, a validation set, and a test set. The AI model may be trained based on data samples included in the train set, performance of the AI model which is being trained may be evaluated based on data samples included in the validation set, and performance of the AI model which has been trained may be evaluated based on data samples included in the train set.

In an embodiment, the electronic device may obtain a GT data sample based on the data samples included in the merged data set, and the merged data set may further include the GT data sample. With regard to a GT data sample, for additional implementation details, refer to the descriptions of FIGS. 4A and 4B.

The electronic device may obtain a GT data sample including a GT region based on GT region information of the merged data set. The GT region information may include at least one of GT bounding box information or GT pixel information.

In an embodiment, the electronic device may obtain a GT data sample by setting a region excluding the GT region to a certain value. In an embodiment, the electronic device may obtain a GT data sample based on padding information. In an embodiment, the electronic device may obtain a GT data sample by using a Gaussian filter. In an embodiment, in a GT data sample, at least one GT region may be further erased or set to a preset value.

The electronic device may update a parameter of the AI model based on the GT data sample. For example, the electronic device may train the AI model and evaluate performance of the AI model based on the GT data sample and the data samples included in the existing merged data set. The electronic device may train the AI model based on the GT data sample and evaluate performance of the AI model based on the data samples included in the existing merged data set.

In operation S820, the electronic device may calculate a first loss based on GT data and a prediction result obtained by applying a first data sample included in the merged data set to the AI model.

In an embodiment, the first data sample may be a data sample included in the train set of the merged data set. In an embodiment, the AI model may include at least one of a classification model, an object detection model, a segmentation model, a pose estimation model, a HOI model, or a VRD model.

For example, in the case in which the AI model is a classification model, the prediction result obtained by inputting the first data sample to the AI model may include probability information corresponding to a class. Probability corresponding to a class may indicate probability that an object corresponding to the class will be included in an image. GT data of the first data sample may indicate whether an object corresponding to a class is included.

For example, in the case in which the AI model is an object detection model, the prediction result obtained by inputting the first data sample to the AI model may include at least one of position information of an object or class information corresponding to the object. The position information of the object may be expressed as a bounding box. The GT data of the first data sample may indicate at least one of a position of an object or a class corresponding to the object. With regard to the pose estimation model, the segmentation model, the VRD model, and the HOI model, for additional implementation details, reference may be made to the descriptions of FIGS. 5 to 7.

The electronic device may obtain a prediction result by applying the first data sample to the AI model. In an embodiment, the prediction result may include a prediction result corresponding to all classes of the merged data set.

The GT data of the first data sample may include GT data corresponding to the all classes of the merged data set. The GT data of the first data sample may include GT data corresponding to a GT class and GT data corresponding to all classes excluding the GT class. In an embodiment, in the GT data of the first data sample, a default value such as 0 may be set as a value corresponding to the all classes excluding the GT class.

In an embodiment, the electronic device may calculate a first loss by applying the prediction result of the first data sample and the GT data of the first data sample to a loss function. The electronic device may calculate a first loss based on a prediction result corresponding to a class and GT data corresponding to the class.

For example, when gt represents GT data, pred represents a prediction result, and L is a loss function, a first loss L₁ may be calculated based on the following Equation 1.

L₁=L(gt,pred) Equation 1

The loss function may include at least one of cross-entropy loss, hinge loss, mean absolute error (MAE), mean squared error (MSE), Kullback-Leibler divergence (KLD) loss, Huber loss, or root mean squared error (RMSE). The loss function is not limited to the above-mentioned loss functions, and various loss functions and cost functions may be applied.

For example, in the case in which the loss function is MSE, the first loss may be calculated based on the following Equation

$$\frac{1}{n} {\sum }_{i = 1}^{n} {( {gt}_{i} - {pred}_{i} )}^{2} .$$

For example, in the case in which the loss function is RMSE, the first loss may be calculated based on the following Equation

$$\sqrt{\frac{1}{n} {\sum }_{i = 1}^{n} {( {gt}_{i} - {pred}_{i} )}^{2}} .$$

For example, in the case in which the loss function is MAE, the first loss may be calculated based on Equation

$$\frac{1}{n} {\sum }_{i = 1}^{n} \vert {gt}_{i} - {pred}_{i} \vert .$$

For example, in the case in which the loss function is cross-entropy loss, the first loss may be calculated based on Equation

$$- {\sum }_{i = 1}^{n} [ ( {gt}_{i} log ( {pred}_{i} ) + ( 1 - {gt}_{i} ) log ( 1 - {pred}_{i} ) ) ] .$$

“i” may be defined as a identifier of a class, rᵢ may be defined as a loss weight value mapped to the class i, pred₁ may be defined as a prediction result corresponding to the class i, gt₁ may be defined as GT data corresponding to the class i, and n may be defined as the number of classes.

In an embodiment, the electronic device may calculate a first loss based on a prediction result obtained by applying a plurality of first data samples included in the merged data set to the AI model and GT data of the plurality of first data samples.

A method of calculating a first loss based on a plurality of first data samples may correspond to a method of calculating a first loss as described above. The first loss calculated based on the plurality of first data samples may be expressed as an average or sum.

In operation S830, the electronic device may calculate a second loss based on the first loss and loss weight value information corresponding to the first data sample.

In an embodiment, the electronic device may calculate a second loss based on the prediction result obtained by applying the first data sample to the AI model, the GT data of the first data sample, and the loss weight value information of the first data sample.

In an embodiment, the electronic device may calculate a second loss by applying the prediction result obtained by applying the first data sample included in the merged data set to the AI model, the GT data of the first data sample, and the loss weight value information to a loss function. The electronic device may calculate the second loss by multiplying a loss weight value for each class in the loss function.

The loss function may include at least one of cross-entropy loss, hinge loss, MAE, MSE, KLD loss, Huber loss, or RMSE. The loss function is not limited to the above-mentioned loss functions, and various loss functions and cost functions may be applied.

For example, in the case in which the loss function is MSE, the second loss may be calculated based on the following Equation

$$\frac{1}{n} {\sum }_{i = 1}^{n} {{r}_{i} ( {gt}_{i} - {pred}_{i} )}^{2} .$$

For example, in the case in which the loss function is RMSE, the second loss may be calculated based on the following Equation

$$\sqrt{\frac{1}{n} {\sum }_{i = 1}^{n} {{r}_{i} ( {gt}_{i} - {pred}_{i} )}^{2}} .$$

For example, in the case in which the loss function is MAE, the second loss may be calculated based on the following Equation

$$\frac{1}{n} {\sum }_{i = 1}^{n} {r}_{i} \vert {gt}_{i} - {pred}_{i} \vert .$$

For example, in the case in which the loss function is cross-entropy loss, the second loss may be calculated based on the following Equation

$$- {\sum }_{i = 1}^{n} {r}_{i} [ ( {gt}_{i} log ( {pred}_{i} ) + ( 1 - {gt}_{i} ) log ( 1 - {pred}_{i} ) ) ] .$$

“i” may be defined as a identifier of a class, rᵢ may be defined as a loss weight value mapped to the class i, pred₁ may be defined as a prediction result corresponding to the class i, gt₁ may be defined as GT data corresponding to the class i, and n may be defined as the number of classes.

The loss weight value information may include loss weight values mapped to the classes of the merged data set. For example, in the case in which the classes of the merged data set are {c1, c2, c3}, the loss weight value information may include a loss weight value m1 mapped to the class c1, a loss weight value m2 mapped to the class c2, and a loss weight value m3 mapped to c3, such as {m1, m2, m3}.

In an embodiment, the loss weight value information may include a first loss weight value mapped to a GT class and a second loss weight value mapped to all classes excluding the GT class.

In an embodiment, the electronic device may determine loss weight value information corresponding to the first data sample such that the first loss weight value is greater than or equal to the second loss weight value. In an embodiment, in the case in which the first loss weight value is 1, the second loss weight value may be determined as a value that is greater than or equal to 0 and less than or equal to 1.

In an embodiment, the electronic device may calculate a second loss based on the first loss and the loss weight value information corresponding to the first data sample.

The electronic device may obtain or determine loss weight value information of the plurality of source data sets. For example, the electronic device may obtain or determine loss weight value information of the first source data set and loss weight value information of the second source data set.

The loss weight value information corresponding to the first data sample may include loss weight value information of a source data set corresponding to the first data sample. The electronic device may identify a source data set corresponding to the first data sample. The source data set corresponding to the first data sample may be understood as a source data set in which the first data sample has been included.

For example, in the case in which the first data sample has been a data sample included in the first source data set, a source data set corresponding to the first data sample may be the first source data set. As another example, in the case in which the first data sample has been a data sample included in the second source data set, a source data set corresponding to the first data sample may be the second source data set.

The electronic device may determine loss weight value information of the source data set based on at least one of information about GT classes of the source data set or information about a degree of learning progress. The electronic device may identify whether all classes of the merged data set are the GT classes of the source data set based on the information about the GT classes of the source data set.

The loss weight value information of the source data set may include a first loss weight value mapped to the GT classes of the source data set and a second loss weight value mapped to all classes except for the GT classes.

The electronic device may determine, based on the information about the degree of learning progress, a first loss weight value mapped to the GT classes and a second loss weight value mapped to all classes excluding the GT classes such that the first loss weight value is greater than or equal to the second loss weight value.

For example, in the case in which classes of the merged data set are {c1, c2, c3} and GT classes of the first source data set are {c1, c2}, the electronic device may determine first loss weight values {m1, m2} mapped to the GT classes {c1, c2} and a second loss weight value {m3} mapped to all class {c3} excluding the GT classes such that each of the first loss weight values {m1, m2} is greater than or equal to the second loss weight value {m3}.

In an embodiment, the information about the degree of learning progress may include at least one of a confidence of the AI model or a learning step of the AI model. As at least one of the confidence of the AI model or the learning step of the AI model increases, the electronic device may determine a decrease of the second loss weight value.

The electronic device may determine a confidence of the AI model or a learning step of the AI model. The leaning step of the AI model may be determined based on epoch or step. The confidence of the AI model may include a confidence of the AI model corresponding to a class. In an embodiment, the confidence of the AI model may be obtained based on a data sample of a validation set or a data sample of a test sample.

In an embodiment, in the case in which the first loss weight value is 1, the electronic device may calculate a second loss weight value based on Equation rᵢ=1/((1+Cᵢ)^{a}×(e−1)×β+1).

i may be defined as an identity of a class, rᵢ may be defined as a second loss weight value mapped to the class i, cᵢ may be defined as a confidence of an AI model corresponding to the class i, e may be defined as a learning step of the AI model, which is expressed as an integer that is greater than or equal to 1, a may be defined as a first configured value, and β may be defined as a second configured value.

In an embodiment, the electronic device may obtain a plurality of second prediction results by applying, to the AI model, a plurality of second data samples in which GT data corresponds to a class i. The electronic device may determine a confidence of the AI model corresponding to the class i based on the plurality of second prediction results regarding the class i and GT data of the plurality of second data samples.

By comparing the second prediction results corresponding to the class i to the GT data of the second data samples corresponding to the class i, a confidence may be measured, and an average of confidences calculated with respect to the plurality of second data samples may be determined as a confidence of the AI model corresponding to the class i.

For example, in the case in which the AI model is a classification model, an image in which GT data corresponding to the class i exists may be used as a second data sample. The AI model may be trained based on a data sample in which GT data for a person class exists. In the case in which a confidence of the AI model corresponding to the class i is 1, it may correspond to the case where the AI model has classified all of the plurality of second data samples into the same class as that of the GT data, and in the case in which a confidence of the AI model is 0, it may correspond to the case where the AI model has classified all of the plurality of second data samples into a different class from that of the GT data.

For example, in the case in which the AI model is an object detection model, a data sample including a bounding box inferred to be the class i may be used as a second data sample. Intersection over union (IoU) may be calculated based on a bounding box of a prediction result inferred to be the class i and a bounding box of the GT data. A confidence of the AI model corresponding to the class i may be determined based on an IoU average value of the plurality of second data samples.

Loss weight value information of the plurality of source data sets may be obtained (or determined) after operation S820 is performed, obtaining (or determining) loss weight value information of the plurality of source data sets may be performed simultaneously with operation S820, or operation S820 may be performed after loss weight value information of the plurality of source data sets are obtained (or determined).

In operation S840, the electronic device may update a parameter of the AI model based on the second loss.

The parameter of the AI model may include one or more weight values, or one or more biases. The electronic device may update at least one of at least one weight value or at least one bias based on the second loss. The electronic device may train the AI model to decrease the second loss through backpropagation.

The electronic device may train the AI model to process a vision task. The electronic device may process a vision task by using the AI model. A task may include at least one of classification, object detection, segmentation, pose estimation, VRD, or HOI. A method of performing a task by using an AI model may correspond to descriptions of FIGS. 5 to 7. The electronic device may process various tasks, such as machine learning, natural language processing, voice recognition, voice processing, and speaker recognition.

The electronic device may obtain input data required to process a task. For example, the input data may be an image including at least one object. The electronic device may output a result corresponding to the task by inputting the input data to the AI model.

A trained AI model may output a prediction or inference value corresponding to each task in response to an input. A processor 920 or a second processor may provide a preset service through an additional processing task on an output value.

For example, when a classification task is performed, a result corresponding to the task may output a prediction value associated with a class corresponding to at least one object included in an image.

For convenience of description, in some descriptions, an example in which an AI model is a model that performs a task of a computer vision field is described. A kind or function of an AI model described in the present disclosure is not limited thereto, and the AI model may be an AI model that may be used in various fields, such as voice recognition, or natural language processing, for example.

Steps or operations of the flowchart may be merged, added with another one(s), or implemented in a different order in actual implementation. Two or more operations may be performed simultaneously or one operation may be subdivided into two or more operations and performed.

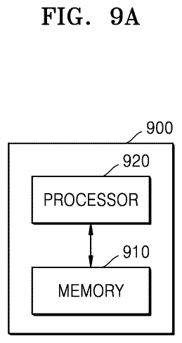

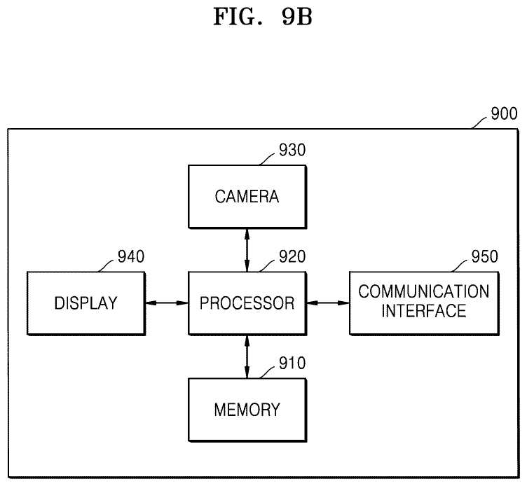

FIGS. 9A and 9B are block diagrams related to an electronic device according to an embodiment.

Referring to FIG. 9A, an electronic device 900 according to an embodiment may include memory 910 and the processor 920.

Instructions, data structures, and program code which are readable by the processor 920 may be stored in the memory 910. Operations that are performed by the processor 920 may be implemented by executing instructions or codes of a program stored in the memory 910.

The memory 910 may include a flash memory type, a hard disk type, a multimedia card micro type, and card type memory (for example, Secure Digital (SD) memory or extreme Digital (XD) memory), and may include non-volatile memory including at least one of Read-Only Memory (ROM), Electrically Erasable Programmable Read-Only Memory (EEPROM), magnetic memory, or an optical disk, and a volatile memory such as Random Access Memory (RAM) or Static Random Access Memory (SRAM).

The memory 910 according to an embodiment may store one or more instructions and/or programs to control the electronic device 900 to learn or train an AI model. For example, a model training module may be stored in the memory 910.

The processor 920 may execute instructions or a programmed software module stored in the memory 910 to control an operation or function that is performed by the electronic device 900. The processor 920 may be configured as a hardware component that performs arithmetic, logic, and input/output operations and signal processing. For example, the processor 920 may load a model training module stored in the memory 910 and execute the model training module.

The processor 920 may be configured with at least one of, for example, a Central Processing Unit, a microprocessor, a Graphic Processing Unit, an Application Specific Integrated Circuits (ASICs), a Digital Signal Processors (DSPs), a Digital Signal Processing Devices (DSPDs), a Programmable Logic Devices (PLDs), a Field Programmable Gate Arrays (FPGAs), an Application Processor, a Neural Processing Unit, or an artificial intelligence-processor with a hardware structure for processing an artificial intelligence model, although not limited thereto. Each processor constituting the processor 920 may be a dedicated processor for performing a function.

The processor 920 may control an operation or function that is performed by the electronic device 900 by executing instructions or a programmed software module stored in the memory 910. The processor 920 may be configured as a hardware component that performs arithmetic, logic, and input/output operations and signal processing. For example, the processor 920 may load a model training module stored in the memory 910 and execute the model training module.

The processor 920 may control overall operations of the electronic device 900 to train an AI model or process a task using the AI model by executing one or more instructions stored in the memory 910.

As shown in FIG. 9B, the electronic device 900 according to an embodiment may include the memory 910, the processor 920, a camera 930, a display 940, and a communication interface 950.

With regard to the memory 910 and the processor 920, content overlapping with that described with reference to FIG. 10 will be no longer described below. At least one of a model training module or a model executing module may be stored in the memory 910. The processor 920 may load the model training module or the model executing module from the memory 910 and execute the model training module or the model executing module.

The camera 930 may be a hardware module that obtains an image. The camera 930 may photograph an image, such as a picture or a moving picture. The camera 930 may include at least one camera module, and support functions, such as close-up, depth, telephoto, wide-angle, and ultra-wide-angle, according to the electronic device 900.

The display 940 may include an output device that provides information or images, and further include an input device that receives inputs. The output device may include a display panel and a controller that controls the display panel, and may be implemented in various types, such as an Organic Light Emitting Diodes (OLED) display, an Active-Matrix Organic Light-Emitting Diode (AM-OLED) display, or a Liquid Crystal Display (LCD), for example. The input device may receive various formats of inputs from a user, and include at least one of a touch panel, a keypad, or a pen recognition panel. The display 940 may be provided in the form of a touch screen into which a display panel and a touch panel are combined, and may be implemented to be flexible or foldable.

The communication interface 950 may perform wired or wireless communication with another device or a network. The communication interface 950 may include communication circuitry or a communication module that supports at least one of various wired and wireless communication methods. For example, the communication interface 950 may perform data communication between the electronic device 900 and other devices by using at least one of data communication methods including, for example, wired Local Area Network (LAN), wireless LAN, Wireless-Fidelity (Wi-Fi), Bluetooth, ZigBee, Wi-Fi Direct (WFD), infrared Data Association (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliances (WiGig), and radio-frequency RF communication.

The communication interface 950 according to an embodiment may transmit/receive an AI model or a training data set used to train an AI model to/from an external device. The communication interface 950 may transmit an image photographed through the camera 930 of the electronic device 900 to a server, or receive an AI model or a data set trained in the server.

The processor 920 or a first processor constituting the processor 920 may execute the model training module to train the AI model. The processor 920 or the first processor may train the AI model by using a merged data set or a train data set of the merged data set. The merged data set or the train data set may be classified based on data attribute information, such as a time or place at which the data has been generated, a size of the data, a generator of the data, and a data type, and may be used to train the model.

For example, in the case in which the AI model is a vision model, the processor 920 or the first processor may obtain a plurality of images to train the model. The processor 920 or the first processor may obtain an image through the camera 930 of the electronic device 900 or may obtain an image from an external device through the communication interface 950. The processor 920 or the first processor may perform pre-processing on the obtained image or may select input data for training the model from a training data set.

The processor 920 or the first processor may learn or train the AI model by using a learning algorithm including error back-propagation or gradient descent.

The processor 920 or a second processor constituting the processor 920 may execute the model executing module to process a task. The task may include at least one of a classification task, an object detection task, a segmentation task, a pose estimation task, a VRD task, or a HOI task. A method of performing each task may correspond to descriptions of FIGS. 5 to 7.

The processor 920 or the second processor may obtain input data required to process the task. The processor 920 or the second processor may input the input data to the AI model and output a result corresponding to the task.

A trained AI model may output a prediction or inference value corresponding to each task in response to an input. The processor 920 or the second processor may perform an additional processing task on an output value and provide a preset service.

One of the model training module or the model executing module may be installed in the electronic device 900, and the remaining one may be installed in a server. The electronic device 900 and the server may provide information about a model established in the model training module installed in any device to the model executing module installed in another device through communication. The electronic device 900 and the server may provide a data set input to the model executing module installed in any device to the model training module installed in another device through communication.

Some components of the block diagram may be integrated into one component, or another component may be added, according to a device actually implemented. Two or more components may be integrated into one component or one component may be subdivided into two or more components. A function that is performed in each block is provided to describe embodiments, and detailed operations or devices therefor do not limit the scope of the disclosure.

Methods provided in various embodiments may be implemented in a program command form that can be executed by various computer means, and may be recorded on computer-readable media. The computer-readable media may also include, alone or in combination with program commands, data files, data structures, and the like. Program commands recorded in the media may be the kind for the present disclosure or available to those of ordinary skill in the computer software field.

Examples of the computer-readable media may include magnetic media, such as hard disks, floppy disks, and magnetic tapes, optical media, such as compact disc-read only memory (CD-ROM) and digital versatile discs (DVD), magneto-optical media such as floptical disks, and hardware devices, such as read only memory (ROM), random access memory (RAM), flash memory, and the like, configured to store and execute program commands. The methods may be stored in memory configured with a combination of some or all of these. Each configuration memory may be included as a plurality of pieces. Examples of the program commands may include high-level language codes that can be executed on a computer through an interpreter or the like, as well as machine language codes produced by a compiler.

The computer-readable media may be provided in the form of non-transitory recording media Herein, ‘non-transitory recording media’ means that the recording media are tangible devices and do not include a signal (e.g., an electromagnetic wave), but this term does not differentiate between where data is semi-permanently stored in the recording medium and where the data is temporarily stored in the recording medium. For example, ‘non-transitory recording media’ may include a buffer in which data is temporarily stored.

The program may be stored in an attachable storage device that may be accessed through communication networks such as the Internet, Intranet, a LAN, a wide area network (WLAN), or a storage region network (SAN) or a communication network configured in a combination thereof. The storage device may access a device for performing the embodiments through an external port. A separate storage device on the communication network may also access the device for performing the embodiments.

An operation method of the electronic device according to the disclosed embodiments may be included and provided in a computer program product. The computer program product may be traded as a product between a seller and a buyer.

The computer program product may include a software (S/W) program or a computer-readable storage medium storing a S/W program. For example, the computer program product may include a S/W program product (for example, a downloadable application) electronically distributed through a manufacturing company of an electronic device or an electronic market (for example, Google Play Store or App Store). For electronic distribution, at least one part of the S/W program may be stored in a storage medium or temporarily created. The storage medium may be a storage medium of a server of a manufacturing company, a server of an electronic market, or a relay server that temporarily stores a S/W program.

In a system configured with a server and an electronic device, the computer program product may include a storage medium of the server or a storage medium of the electronic device. When there is a third device (for example, a smart phone) communicating with the server or the electronic device, the computer program product may include a storage medium of the third device. The computer program product may include a S/W program that is transmitted from the server to the electronic device or the third device or from the third device to the electronic device.

One of the server, the electronic device, or the third device may execute the computer program product to perform the method according to the disclosed embodiments. Two or more of the server, the electronic device, and the third device may execute the computer program product to distributively perform the method according to the disclosed embodiments.

For example, the server may execute the computer program product stored in the server to control the electronic device communicatively connected to the server to perform the method according to the disclosed embodiments.

The electronic device that trains an AI model may include memory storing at least one instruction and at least one processor.

The at least one processor may obtain a merged data set based on a plurality of source data sets. All classes of the merged data set may include all GT classes of the plurality of source data sets in which GT data exists. The at least one processor may calculate a first loss based on GT data of a first data sample included in the merged data set and a prediction result obtained by applying the first data sample to an AI model. The at least one processor may calculate a second loss based on the first loss and loss weight value information corresponding to the first data sample. The at least one processor may update at least one parameter of the AI model based on the second loss.

The at least one processor may identify a source data set corresponding to the first data sample. The at least one processor may determine loss weight value information of the identified source data set based on at least one of information about GT classes of the identified source data set or information about a degree of learning progress of the AI model. The at least one processor may calculate a second loss based on the first loss and the loss weight value information of the identified source data set.

The at least one processor may identify whether the all classes are the GT classes of the identified source data set based on the information about the GT classes. The at least one processor may determine a first loss weight value mapped to the GT classes and a second loss weight value mapped to the all classes excluding the GT classes such that the first loss weight value is greater than or equal to the second loss weight value. Loss weight value information of the identified source data set including the first loss weight value and the second loss weight value may be determined.

The information about the degree of learning progress may include at least one of a confidence of the AI model or a learning step of the AI model. The at least one processor may determine the first loss weight value and the second loss weight value. The at least one processor may determine the confidence of the AI model or the learning step of the AI model. The at least one processor may determine a decrease of the second loss weight value when at least one of the confidence of the AI model or the learning step of the AI model increases.

The at least one processor may calculate the second loss weight value based on Equation rᵢ=1/((1+Cᵢ)^{a}×(e−1)×β+1) when the first loss weight value is 1. i is may be defined as an identifier of a class, rᵢ may be defined as a second loss weight value mapped to the class i, cᵢ may be defined as a confidence of an AI model corresponding to the class i, e may be defined as a learning step of the AI model, which is expressed as an integer that is greater than or equal to 1, a may be defined as a first configured value, and β may be defined as a second configured value.

The at least one processor may obtain a plurality of second prediction results regarding the class i by applying, to the AI model, a plurality of second data samples in which GT data exists in the class i. A confidence of the AI model corresponding to the class i may be determined based on the plurality of second prediction results and the GT data of the plurality of second data samples. The second data samples may be included in the merged data set.

The at least one processor may determine the leaning step of the AI model based on the number of times which the AI model has learned a plurality of data samples including the first data sample.

The first loss may be calculated by applying the prediction result of the first data sample and the GT data of the first data sample to a loss function. The loss function may include at least one of cross-entropy loss, hinge loss, MAE, MSE, KLD loss, Huber loss, or RMSE.

The at least one processor may identify a GT region corresponding to GT data from data samples included in the merged data set. The at least one processor may obtain a GT data sample including only the GT region. The at least one processor may update a parameter of the AI model based on the GT data sample.

The at least one processor may obtain a GT data sample in which a region of the data samples excluding the GT region is set to a third configured value.

The AI model may include at least one of a classification model, an object detection model, a segmentation model, a pose estimation model, a HOI model, or a VRD model.

In the detailed embodiments described above, components included in the disclosure have been expressed in the singular or plural according to the detailed embodiments. The expressions in the singular or plural have been appropriately selected for situations suggested for convenience of description, and the present disclosure is not limited to the components expressed in the singular or plural. Even the components expressed in the plural may be configured as a single component, or even the component expressed in the singular may be configured as plural components.

Although the embodiments have been described in detail, the scope of the disclosure is not limited to these embodiments. It will be understood that various modifications and variations may be made by those skilled in the art based on the fundamental concept of the present disclosure as defined by the appended claims.

What is claimed is:

1. A method of training an Artificial Intelligence (AI) model, comprising:
obtaining a merged data set, based on a plurality of source data sets, wherein the merged data set comprises a plurality of Ground-Truth (GT) classes from among the plurality of source data sets that comprise GT data;
obtaining a prediction result by applying a first plurality of data samples of the merged data set to the AI model, and calculating a first loss based on the prediction result and first GT data of the first plurality of data samples;
calculating a second loss, based on the first loss and first loss weight value information corresponding to the first plurality of data samples; and
generating an updated AI model by updating at least one parameter of the AI model, based on the second loss.

2. The method of claim 1, wherein the calculating the second loss comprises:
identifying a first plurality of source data sets corresponding to the first plurality of data samples;
determining second loss weight value information of the first plurality of source data sets, based on at least one of information about a first plurality of GT classes of the first plurality of source data sets or information about a plurality of degrees of learning progress of the AI model; and
calculating the second loss, based on the first loss and the second loss weight value information.

3. The method of claim 2, wherein the determining the second loss weight value information comprises:
identifying whether all classes of the merged data set are the first plurality of GT classes, based on the information about the first plurality of GT classes;
determining a first loss weight value mapped to the first plurality of GT classes and a second loss weight value mapped to all of the classes of the merged data set, excluding the first plurality of GT classes, such that the first loss weight value is greater than or equal to the second loss weight value; and
determining the second loss weight value information of the first plurality of source data sets, wherein the second loss weight value information comprises the first loss weight value and the second loss weight value.

4. The method of claim 3, wherein the information about the plurality of degrees of the learning progress comprises at least one of a confidence of the AI model or a learning step of the AI model, and
wherein the determining the first loss weight value and the second loss weight value comprises:
determining the confidence of the AI model or the learning step of the AI model; and
determining a decrease of the second loss weight value, based on at least one of the confidence of the AI model or the learning step of the AI model increasing.

5. The method of claim 4, wherein the determining the first loss weight value and the second loss weight value comprises:
calculating the second loss weight value, based on Equation; rᵢ=1/((1+Cᵢ)^{a}×(e−1)×β+1), based on the first loss weight value being 1,
wherein i is an identifier of a class, rᵢ is a second loss weight value mapped to the class i, cᵢ is a confidence of an AI model corresponding to the class i, e is a learning step of the AI model expressed as an integer of 1 or more, a is a first configured value, and β is a second configured value.

6. The method of claim 5, wherein the determining the confidence of the AI model or the learning step of the AI model comprises:
obtaining a plurality of prediction results for the class i by applying, to the AI model, a second plurality of data samples of the merged data set comprising second GT data of the class i; and
determining the confidence of the AI model corresponding to the class i, based on the plurality of prediction results and the second GT data.

7. The method of claim 4, wherein the determining the first loss weight value and the second loss weight value comprises determining the learning step of the AI model, and
wherein the learning step of the AI model is determined, based on a number of times the AI model has learned a plurality of data samples including the first plurality of data samples.

8. The method of claim 1, wherein the first loss is calculated by applying the prediction result and the first GT data to a loss function, and
wherein the loss function is based on at least one of cross-entropy loss, hinge loss, mean absolute error (MAE), mean squared error (MSE), Kullback-Leibler divergence (KLD) loss, Huber loss, or root mean squared error (RMSE).

9. The method of claim 1, further comprising:
identifying a first GT region corresponding to the first GT data from a second plurality of data samples in the merged data set;
obtaining a first GT data sample including the first GT region; and
updating a parameter of the AI model, based on the first GT data sample.

10. The method of claim 9, wherein the obtaining the first GT data sample comprises obtaining a second GT data sample from the second plurality of data samples that excludes the first GT region, and setting the second GT data sample to a third configured value.

11. The method of claim 1, wherein the AI model comprises at least one of a classification model, an object detection model, a segmentation model, a pose estimation model, a Human Object Interaction (HOI) model, or a visual relationship detection (VRD) model.

12. An electronic device for training an Artificial Intelligence (AI) model, comprising:
memory storing instructions; and
at least one processor,
wherein the instructions, when executed by the at least one processor, cause the electronic device to:
obtain a merged data set, based on a plurality of source data sets, wherein the merged data set comprises a plurality of Ground-Truth (GT) classes from among the plurality of source data sets that comprise GT data;
obtain a prediction result by applying a first plurality of data samples of the merged data set to the AI model, and calculate a first loss based on the prediction result and first ground-truth data of the first plurality of data samples;
calculate a second loss, based on the first loss and first loss weight value information corresponding to the first plurality of data samples; and
generate an updated AI model by updating at least one parameter of the AI model, based on the second loss.

13. The electronic device of claim 12, wherein the instructions, when executed by the at least one processor, cause the electronic device to:
identify a first plurality of source data sets corresponding to the first plurality of data samples;
determine second loss weight value information of the first plurality of source data sets, based on at least one of information about a first plurality of GT classes of the first plurality of source data sets or information about a plurality of degrees of learning progress of the AI model; and
calculate the second loss, based on the first loss and the second loss weight value information.

14. The electronic device of claim 13, wherein the instructions, when executed by the at least one processor, cause the electronic device to:
identify whether all classes of the merged data set are the first plurality of GT classes based on the information about the first plurality of GT classes;
determine a first loss weight value mapped to the first plurality of GT classes and a second loss weight value mapped to all of the classes of the merged data set, excluding the first plurality of GT classes, such that the first loss weight value is greater than or equal to the second loss weight value; and
determine the second loss weight value information of the first plurality of source data sets, wherein the second loss weight value information comprises the first loss weight value and the second loss weight value,

15. A non-transitory computer-readable recording medium having instructions recorded thereon, that, when executed by one or more processors, cause the one or more processors to:
obtain a merged data set, based on a plurality of source data sets, wherein the merged data set comprises a plurality of Ground-Truth (GT) classes from among the plurality of source data sets that comprise GT data;
obtain a prediction result by applying a first plurality of data samples of the merged data set to the AI model, and calculate a first loss based on the prediction result and first ground-truth data of the first plurality of data samples;
calculate a second loss, based on the first loss and first loss weight value information corresponding to the first plurality of data samples; and
generate an updated AI model by updating at least one parameter of the AI model, based on the second loss.
